(19) United States
(12) Patent Application Publication
(10) Pub. No.: US 2021/0252637 A1
(43) Pub. Date: Aug. 19, 2021

(54) LASER-JET LIQUID BEAM SELF-GENERATED ABRASIVE PARTICLE FLOW COMPOSITE PROCESSING DEVICE AND METHOD

(71) Applicant: Shufeng SUN, Wenzhou, Zhejiang (CN)

(72) Inventors: Pingping WANG, Qingdao (CN); Qiangqiang LV, Qingdao (CN); Shufeng SUN, Wenzhou (CN); Mengfan SUN, Qingdao (CN); Meng SUN, Qingdao (CN)

(73) Assignee: Shufeng SUN, Wenzhou, Zhejiang (CN)

(21) Appl. No.: 16/954,249

(22) PCT Filed: Nov. 22, 2019
(86) PCT No.: PCT/CN2019/120386

§ 371 Date: Jun. 16, 2020

(30) Foreign Application Priority Data
Apr. 25, 2019 (CN) 2019103396520

(51) Int. Cl. B23K 26/146; B23K 26/00; B23K 26/36; B23K 26/06; B24C 9/00

(52) U.S. Cl. CPC B23K 26/146; B23K 26/0093; B24C 9/00; B23K 26/0643; B23K 26/36

(57) ABSTRACT

A laser-jet liquid beam self-generated abrasive particle flow composite processing device and a method, the device including a spraying nozzle and a work box, wherein the spraying nozzle is connected with a supplying mechanism configured to supply a salt saturated solution at a set pressure to the spraying nozzle; the spraying nozzle is connected with a cooling mechanism configured to cool the salt saturated solution inside the spraying nozzle and precipitate fine crystal grains from the salt saturated solution; the spraying nozzle is further connected with a mirror tube; the mirror tube is connected with a laser generating mechanism configured to generate laser rays; and the work box is configured to fix a workpiece and collect the salt saturated solution sprayed by the spraying nozzle. The processing device can effectively improve processing quality of the workpiece.

### BACKGROUND

### Technical Field

The present invention relates to the technical field of mechanical processing equipment, in particular to a laser-jet liquid beam self-generated abrasive particle flow composite processing device and a method.

### Related Art

With continuous development of laser industry in China, manufacturing industry puts forward higher requirements on precision and roughness of a laser processed workpiece. Conventional laser processing belongs to thermal processing, that is, through high temperature of laser, the surface of a processed material is melted and gasified so as to achieve a purpose of removing the material. However, the inventor discovers that a recasting layer formed by melt through accumulation may inevitably occur in a laser processing area, so that the roughness after processing is increased. Secondly, by laser processing (such as perforation), the roughness of a hole wall is generally very high, and hole diameters are irregular.

### SUMMARY

The present invention aims at overcoming the above defects in the prior art to provide a laser-jet liquid beam self-generated abrasive particle flow composite processing device capable of effectively removing a recast layer on a surface of a material subjected to laser processing and reducing a roughness value, thus improving processing quality of a workpiece.

In order to achieve the above objective, the present invention adopts the following technical scheme:

a laser-jet liquid beam self-generated abrasive particle flow composite processing device comprises:

a spraying nozzle, wherein the spraying nozzle is connected with a supplying mechanism configured to supply a salt saturated solution at a set pressure to the spraying nozzle; the spraying nozzle is connected with a cooling mechanism configured to cool the salt saturated solution inside the spraying nozzle and precipitate fine crystal grains from the salt saturated solution; the spraying nozzle may spray out the fine crystal grains along with the salt saturated solution to perform impact and grinding on the surface of the workpiece; the spraying nozzle is further connected with a mirror tube; and the mirror tube is connected with a laser generating mechanism configured to generate laser rays; and a work box, configured to fix the workpiece and collect the salt saturated solution sprayed out by the spraying nozzle.

The present invention has a following work principle: the supplying mechanism supplies the salt saturated solution at the set pressure into the spraying nozzle; the salt saturated solution is sprayed out by the spraying nozzle; the laser rays generated by the laser generating mechanism are guided into the spraying nozzle through a reflecting mirror and are emitted out through the spraying nozzle to perform laser processing on the workpiece; while the workpiece is processed by the laser rays, the cooling mechanism may cool the saturated salt solution in the spraying nozzle; fine crystal grains are precipitated out from the saturated salt solution, and the precipitated fine crystal grains may be sprayed out along with the saturated salt solution to perform impact and grinding on the surface of the workpiece.

### Advantageous Effects of the Present Invention:

The processing device of the present invention has the advantageous effects that during laser processing, the cooling mechanism may be utilized to precipitate the fine crystal grains from the salt saturated solution, the fine crystal grains are sprayed out along with the saturated salt solution to perform grinding and impact on the workpiece, the recast layer generated through laser processing on the workpiece may be effectively removed, and the roughness of the surface of the workpiece is reduced, thus improving the processing quality of the workpiece.

### BRIEF DESCRIPTION OF THE DRAWINGS

The accompanying drawings constituting a part of this application are used for providing further understanding for this application. Exemplary embodiments of this application and descriptions thereof are used for explaining this application and do not constitute a limitation to this application.

FIG. 1 is a whole schematic structure diagram according to an embodiment 1 of the present invention.

FIG. 2 is a schematic assembling diagram of a spraying nozzle and a mirror tube according to the embodiment 1 of the present invention.

FIG. 3 is a schematic cross-sectional diagram of a cooling jacket according to the embodiment 1 of the present invention.

FIG. 4 is a schematic diagram of an inside of the spraying nozzle and the mirror tube according to the embodiment 1 of the present invention.

FIG. 5 is a schematic assembling diagram of a vertical driving mechanism, a two-axis linkage mechanism and a rotating mechanism assembly according to the embodiment 1 of the present invention.

FIG. 6 is a schematic structure diagram of a processing center formed according to the embodiment 1 of the present invention.

Wherein numerals in the figures indicate: 1, spraying nozzle; 2, mirror tube; 3, work box; 4, liquid storage box; 5, first pipeline; 6, driving pump; 7, second pipeline; 8, cooling jacket; 8-1, cooling cavity; 9, first cooling pipe; 10, second cooling pipe; 11, compressor; 12, reflecting mirror frame; 13, reflecting mirror; 14, collimating mirror; 15, focusing mirror; 16, transparent sealing lens; 17, laser device; 18, optical cable; 19, connecting plate;

20, vertical support plate; 21, work table; 22, first servo motor; 23, first lead screw transmission mechanism; 24, first slide block; 25, slide rail; 26, second servo motor; 27, horizontal support plate; 28, third servo motor; 29, rotating support frame; 30, rotating plate; 31, fifth servo motor; 32, housing; 33, sliding window; 34, rocker arm; 35, numerical control system; and 36, fourth servo motor.

### DETAILED DESCRIPTION

It should be noted that the following detailed descriptions are all exemplary and are intended to provide a further understanding of this application. Unless otherwise specified, all technical and scientific terms used herein have the same meaning as commonly understood by those of ordinary skill in the art to which this application belongs.

It should be noted that terms used herein are only for describing specific implementations and are not intended to limit exemplary implementations according to this application. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

For convenience of description, the words “above”, “below”, “left”, and “right” only indicate directions consistent with those of the accompanying drawings, are not intended to limit the structure, and are used only for ease and brevity of illustration and description, rather than indicating or implying that the mentioned device or element needs to have a particular orientation or needs to be constructed and operated in a particular orientation. Therefore, such terms should not be construed as a limitation on the present invention.

As described in the related art, during conventional processing of laser, a recast layer may be generated on a surface of a workpiece, and a roughness of the surface of the processed workpiece is high. By aiming at the above problems, the present invention provides a laser-jet liquid beam self-generated abrasive particle flow composite processing device, comprising:

a spraying nozzle, wherein the spraying nozzle is connected with a supplying mechanism configured to supply a salt saturated solution at a set pressure to the spraying nozzle; the spraying nozzle is connected with a cooling mechanism configured to cool the salt saturated solution inside the spraying nozzle and precipitate fine crystal grains from the salt saturated solution; the spraying nozzle may spray out the fine crystal grains along with the salt saturated solution to perform impact and grinding on the surface of the workpiece; the spraying nozzle is further connected with a mirror tube; and the mirror tube is connected with a laser generating mechanism configured to generate laser rays; and a work box, configured to fix the workpiece and collect the salt saturated solution sprayed out by the spraying nozzle.

Further, the supplying mechanism comprises a liquid storage box configured to contain the salt saturated solution; the liquid storage box is connected with the spraying nozzle through a first pipeline; the first pipeline is connected with a driving pump; and the driving pump may drive the salt saturated solution in the liquid storage box to enter the spraying nozzle.

Further, a heating mechanism is disposed in the liquid storage box, and a filter screen is disposed in a connecting position of the liquid storage box and the first pipeline.

Further, the liquid storage box is connected with the work box through a second pipeline.

Further, the cooling mechanism comprises a cooling jacket fixedly connected onto an outer peripheral surface of the spraying nozzle in a sleeving way, a cooling cavity is formed in a pipe wall of the cooling jacket, the cooling cavity communicates with a first cooling pipe and a second cooling pipe, and the first cooling pipe and the second cooling pipe are connected with a compressor.

Further, the laser generating mechanism is a laser device, and the laser device is connected with the mirror tube through an optical cable.

Further, a transparent sealing lens is disposed between the spraying nozzle and the mirror tube, a reflecting mirror configured to guide laser rays into the spraying nozzle is disposed in the mirror tube, a collimating mirror and a focusing mirror which are fixedly connected with the mirror tube are disposed between the reflecting mirror and the transparent sealing lens, and the collimating mirror is disposed adjacent to the reflecting mirror.

Further, the spraying nozzle and the mirror tube are vertically disposed and are connected with a vertical driving mechanism, the vertical driving mechanism may drive the spraying nozzle and the mirror tube to move in a vertical direction, the work box is positioned under the spraying nozzle, the work box is connected with a rotating mechanism assembly, the rotating mechanism assembly is connected with a two-axis linkage mechanism, the two-axis linkage mechanism may drive the rotating mechanism and the work box to move in mutually vertical first direction and second direction in a horizontal plane, and the rotating mechanism assembly may drive the work box to rotate in the vertical direction and the first direction.

Further, the rotating mechanism assembly comprises a first rotating mechanism and a second rotating mechanism, the first rotating mechanism is connected with the work box and is configured to drive the work box to rotate in the vertical direction, and the second rotating mechanism is connected with the first rotating mechanism and is configured to drive the work box to rotate in the first direction.

The present embodiment further discloses a method using the laser-jet liquid beam self-generated abrasive particle flow composite processing device: the laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

The present embodiment will be illustrated in detail with reference to the accompanying drawings hereinafter:

### Embodiment 1:

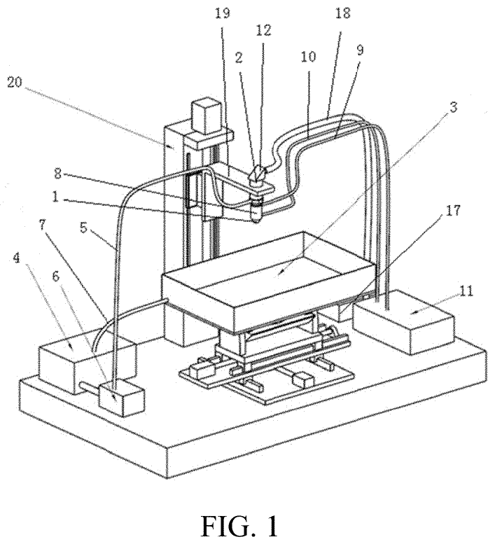

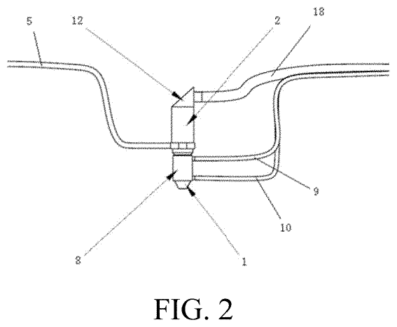

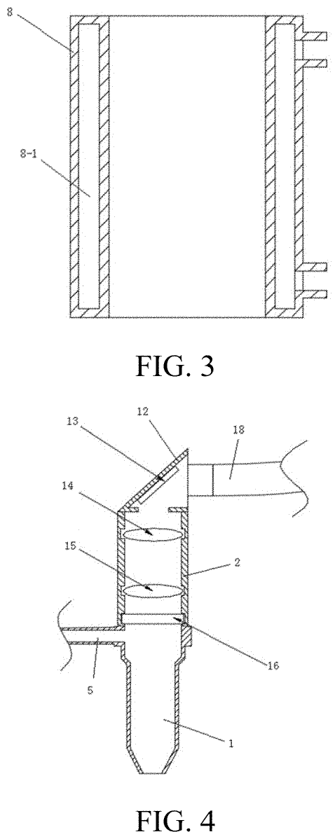

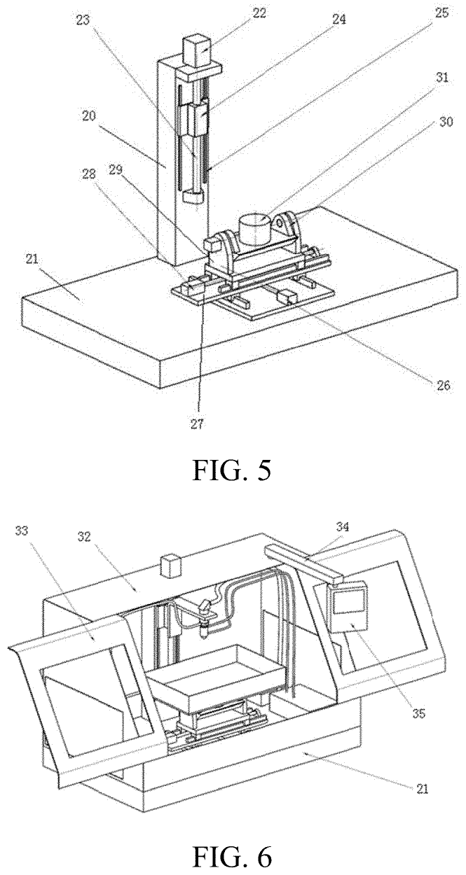

As shown in FIG. 1 to FIG. 6, a laser-jet liquid beam self-generated abrasive particle flow composite processing device comprises a spraying nozzle 1 disposed vertically. A spraying opening is formed in the bottom of the spraying nozzle, and is configured to spray out a salt saturated solution and emit out laser rays. The upper part of the spraying nozzle is connected with a mirror tube 2. A work box 3 is disposed under the spraying nozzle. A workpiece clamping mechanism configured to clamp a workpiece is disposed in the work box. Meanwhile, the workbox may collect the salt saturated solution sprayed out by the spraying nozzle. The workpiece clamping mechanism may select an existing workpiece clamping mechanism matched with the workpiece according to different shapes of the workpiece, and a specific structure thereof is not described in detail herein.

The spraying nozzle is connected with the supplying mechanism. The supply mechanism is configured to provide the salt saturated solution at the set pressure to the spraying nozzle. The supplying mechanism comprises a liquid storage box 4. The liquid storage box is configured to store the salt saturated solution. The liquid storage box is connected with a side wall of the spraying nozzle through a first pipeline 5. The first pipeline communicates with an inside space of the spraying nozzle. The first pipeline is connected with a driving pump 6. The driving pump may drive the salt saturated solution in the liquid storage box to enter the inside space of the spraying nozzle, and then the salt saturated solution is sprayed out by the spraying nozzle. The liquid storage box is further connected with the work box through a second pipeline 7, thus realizing cyclic utilization of the salt saturated solution.

A heating mechanism is disposed in the liquid storage box, and is configured to control a temperature of the salt saturated solution in the liquid storage box. A filter screen is disposed in a connecting position of the liquid storage box and the first pipeline. By using the filter screen, impurities and precipitated crystal grains in the solution may be prevented from entering the driving pump to cause work barriers of the driving pump.

The spraying nozzle is further connected with a cooling mechanism. The cooling mechanism is configured to cool the salt saturated solution in the spraying nozzle to precipitate fine crystal grains from the salt saturated solution. The cooling mechanism comprises a cooling jacket 8 fixedly connected onto an outer surface of a side wall of the spraying nozzle in a sleeving way. A cooling cavity 8-1 is formed inside a pipe wall of the cooling jacket. The cooling cavity communicates with a first cooling pipe 9 and a second cooling pipe 10. The first cooling pipe is disposed above the second cooling pipe. The first cooling pipe and the second cooling pipe are connected with a compressor 11. The compressor may drive a coolant to enter the cooling cavity through the first cooling pipe to exchange heat with the salt saturated solution in the spraying nozzle and cool the salt saturated solution. After heat exchange, vaporized coolant flows back into the compressor through the second cooling pipe.

A bottom end of the mirror tube is fixedly connected with the spraying nozzle. A top end of the mirror tube is connected with a reflecting mirror 13 through a reflecting mirror frame 12. An included angle between the reflecting mirror and a horizontal plane is 45°. A collimating mirror 14 is disposed under the reflecting mirror. A focusing mirror 15 is disposed under the collimating mirror. The collimating mirror and the focusing mirror are both fixedly connected onto an inner side surface of a tube wall of the mirror tube. A transparent sealing lens 16 is disposed in a connecting position of the mirror tube and the spraying nozzle, and is configured to prevent the salt saturated solution from entering the mirror tube to pollute the collimating mirror and the focusing lens.

The mirror tube is connected with a laser generating mechanism. The laser generating mechanism uses a laser device 17. The laser device is connected with the mirror tube through an optical cable 18. The optical cable is disposed horizontally in the connecting position of the mirror tube. The laser device may generate laser rays, and the laser rays enter the inside of the mirror tube through the optical cable. After being reflected by the reflecting mirror, the laser rays enter the spraying nozzle sequentially through the collimating mirror, the focusing mirror and the transparent sealing lens and are emitted out by the spraying nozzle to perform laser processing on a workpiece.

The mirror tube and the spraying nozzle are connected with a vertical driving mechanism through an L-shaped connecting plate 19. The vertical driving mechanism comprises a vertical support plate 20. The vertical support plate is fixed onto a work table 21. A first servo motor 22 is fixed to a top end of the vertical support plate. An output shaft of the first servo motor is connected with a first lead screw transmission mechanism 23 fixed on the vertical support plate. A first slide block 24 of the first lead screw transmission mechanism is fixedly connected with the connecting plate. The first slide block is glidingly connected with a slide rail 25 disposed on the vertical support plate. The first servo motor may drive the mirror tube and the spraying nozzle to move in the vertical direction by using lead screw transmission.

The work box is connected with a rotating mechanism assembly. The rotating mechanism assembly is connected with a two-axis linkage mechanism. The two-axis linkage mechanism may drive the work box and the rotating mechanism assembly to move in mutually vertical first direction and second direction in a horizontal plane.

The two-axis linkage mechanism comprises a second servo motor 26 fixed on the work table. An output shaft of the second servo motor is connected with a second lead screw transmission mechanism distributed in the second direction. A second slide block of the second lead screw transmission mechanism is connected with a horizontal support plate 27.

A third servo motor 28 is fixed onto the horizontal support plate. An output shaft of the third servo motor is connected with a third lead screw transmission mechanism distributed in the first direction. A third slide block of the third lead screw transmission mechanism is connected with the rotating mechanism assembly.

The rotating mechanism assembly comprises a first rotating mechanism and a second rotating mechanism. The first rotating mechanism comprises a rotating support frame 29 fixed on the third slide block. A fourth servo motor 36 is fixed to two ends of the rotating support frame. An output shaft of the fourth servo motor is connected with a rotating plate 30. A second rotating assembly is fixed onto the rotating plate. The second rotating assembly uses a fifth servo motor 31. An output shaft of the fifth servo motor is fixedly connected with the work box. The fourth servo motor may drive the rotating plate and the work box to rotate in the first direction. The fifth servo motor may drive the work box to rotate in the vertical direction.

In the present embodiment, structures such as the two-axis linkage mechanism, the vertical driving mechanism, the liquid storage box, the compressor, the laser device and the driving pump are fixed on the work table. The two-axis linkage mechanism, the vertical driving mechanism, the driving pump, the compressor, the laser, the heating mechanism, etc. are all connected with a numerical control system, and are controlled to work by the numerical control system.

The processing device according to the present embodiment is fixed inside a housing 32. The housing is provided with a sliding window 33. A rocker arm 34 is disposed on the housing. The numerical control system 35 is disposed on the rocker arm. A processing center is formed. The sputtering in a processing area is effectively ensured not reaching to the outside, and injury may not be caused on operators. Secondly, the laser processing should be in a clean environment. Due to existence of the sliding window and the housing, pollution caused by external dust on various kinds of lens in the mirror tube may be effectively prevented. A connection mode of the housing with the sliding window and the rocker arm, i.e., the numerical control system may utilize an existing connecting mode of a numerical control machine tool external housing structure, and it is not described in detail herein.

The present embodiment further discloses a processing method of the laser-jet liquid beam self-generated abrasive particle flow composite processing device:

The salt saturated solution, such as a sodium chloride saturated solution, is contained in the liquid storage box in advance. Those skilled in the art may select a proper salt saturated solution according to practical requirements, and it is not described in detail herein. The heating mechanism is started, so that the salt saturated solution maintains a set temperature.

A workpiece to be processed is fixed in the work box. The laser device, the compressor and the driving pump are started. The laser device generates the laser rays. After being reflected by the reflecting mirror, the laser rays pass through the collimating mirror, the focusing mirror and the transparent sealing lens to enter the spraying nozzle and are emitted out by the spraying nozzle to perform laser processing on the workpiece. Meanwhile, the driving pump drives the salt saturated solution at the set pressure to flow into the spraying nozzle from the liquid storage box and to be sprayed out by the spraying nozzle. The compressor drives the coolant to enter the cooling cavity to exchange heat with the salt saturated solution so that the fine crystal grains are precipitated out from the salt saturated solution and are sprayed out along with the salt saturated solution to perform grinding and impact on the workpiece, thus removing a recast layer generated by laser processing and reducing the roughness of the surface of the workpiece. Through the vertical driving mechanism, the spraying nozzle and the mirror tube may do ascending and descending movement. Meanwhile, the work box may change the position of the workpiece by using the two-axis linkage mechanism and the rotating mechanism assembly so as to realize the processing on different positions of the workpiece.

The processing device according to the present embodiment can effectively remove the recast layer generated by laser processing, and reduce the toughness of the surface of the workpiece, thus improving the quality of the processed workpiece.

The specific implementations of the present invention are described above with reference to the accompanying drawings, but are not intended to limit the protection scope of the present invention. Those skilled in the art should understand that various modifications or deformations may be made without creative efforts based on the technical solutions of the present invention, and such modifications or deformations shall fall within the protection scope of the present invention.

1. A laser-jet liquid beam self-generated abrasive particle flow composite processing device, comprising:
a spraying nozzle, connecting with a supplying mechanism configured to supply a salt saturated solution at a set pressure to the spraying nozzle; the spraying nozzle is connected with a cooling mechanism configured to cool the salt saturated solution inside the spraying nozzle and precipitate fine crystal grains from the salt saturated solution; the spraying nozzle may spray out the fine crystal grains along with the salt saturated solution to perform impact and grinding on the surface of a workpiece; the spraying nozzle is further connected with a mirror tube; and the mirror tube is connected with a laser generating mechanism configured to generate laser rays; and
a work box, configured to fix the workpiece and collect the salt saturated solution sprayed out by the spraying nozzle.

2. The laser-jet liquid beam self-generated abrasive particle flow composite processing device according to claim 1, wherein the supplying mechanism comprises a liquid storage box configured to contain the salt saturated solution; the liquid storage box is connected with the spraying nozzle through a first pipeline; the first pipeline is connected with a driving pump; and the driving pump may drive the salt saturated solution in the liquid storage box to enter the spraying nozzle.

3. The laser-jet liquid beam self-generated abrasive particle flow composite processing device according to claim 2, wherein a heating device is disposed in the liquid storage box, and a filter screen is disposed in a connecting position of the liquid storage box and the first pipeline.

4. The laser-jet liquid beam self-generated abrasive particle flow composite processing device according to claim 2, wherein the liquid storage box is connected with the work box through a second pipeline.

5. The laser-jet liquid beam self-generated abrasive particle flow composite processing device according to claim 1, wherein the cooling mechanism comprises a cooling jacket fixedly connected onto an outer peripheral surface of the spraying nozzle in a sleeving way, a cooling cavity is formed in a pipe wall of the cooling jacket, the cooling cavity communicates with a first cooling pipe and a second cooling pipe, and the first cooling pipe and the second cooling pipe are connected with a compressor.

6. The laser-jet liquid beam self-generated abrasive particle flow composite processing device according to claim 1, wherein the laser generating mechanism is a laser device, and the laser device is connected with a mirror tube through an optical cable.

7. The laser-jet liquid beam self-generated abrasive particle flow composite processing device according to claim 1, wherein a transparent sealing lens is disposed between the spraying nozzle and the mirror tube, a reflecting mirror configured to guide laser rays into the spraying nozzle is disposed in the mirror tube, a collimating mirror and a focusing mirror which are fixedly connected with the mirror tube are disposed between the reflecting mirror and the transparent sealing lens, and the collimating mirror is disposed adjacent to the reflecting mirror.

8. The laser-jet liquid beam self-generated abrasive particle flow composite processing device according to claim 6, wherein the spraying nozzle and the mirror tube are vertically disposed and are connected with a vertical driving mechanism, the vertical driving mechanism may drive the spraying nozzle and the mirror tube to move in a vertical direction, the work box is positioned under the spraying nozzle and connected with a rotating mechanism assembly, the rotating mechanism assembly is connected with a two-axis linkage mechanism, the two-axis linkage mechanism may drive the rotating mechanism and the work box to move in mutually vertical first direction and second direction in a horizontal plane, and the rotating mechanism assembly may drive the work box to rotate in the vertical direction and the first direction.

9. The laser-jet liquid beam self-generated abrasive particle flow composite processing device according to claim 8, wherein the rotating mechanism assembly comprises a first rotating mechanism and a second rotating mechanism, the first rotating mechanism is connected with the work box and is configured to drive the work box to rotate in the vertical direction, and the second rotating mechanism is connected with the first rotating mechanism and is configured to drive the work box to rotate in the first direction.

10. A method of using the laser-jet liquid beam self-generated abrasive particle flow composite processing device according to claim 1, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

11. A method of using the laser-jet liquid beam self-generated abrasive particle flow composite processing device according to claim 2, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

12. A method of using the laser-jet liquid beam self-generated abrasive particle flow composite processing device according to claim 3, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

13. A method of using the laser-jet liquid beam self-generated abrasive particle flow composite processing device according to claim 4, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

14. A method of using the laser-jet liquid beam self-generated abrasive particle flow composite processing device according to claim 5, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

15. A method of using the laser-jet liquid beam self-generated abrasive particle flow composite processing device according to claim 6, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

16. A method of using the laser-jet liquid beam self-generated abrasive particle flow composite processing device according to claim 7, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

17. A method of using the laser-jet liquid beam self-generated abrasive particle flow composite processing device according to claim 8, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.

18. A method of using the laser-jet liquid beam self-generated abrasive particle flow composite processing device according to claim 9, wherein laser rays generated by the laser generating mechanism are guided into the spraying nozzle through the reflecting mirror, and are emitted out by the spraying nozzle to perform laser processing on the workpiece; during laser processing, the supplying mechanism supplies the salt saturated solution at the set pressure to the spraying nozzle, and the salt saturated solution is sprayed out by the spraying nozzle; the cooling mechanism cools the salt saturated solution in the spraying nozzle to precipitate fine crystal grains from the salt saturated solution, and the precipitated fine crystal grains are sprayed out along with the salt saturated solution to perform grinding and impact on the surface of the workpiece.
